(19) United States
(12) Patent Application Publication
(10) Pub. No.: US 2010/0066099 A1
(43) Pub. Date: Mar. 18, 2010

(54) CONFIGURATION TO POWER ELECTRICAL COMPONENTS IN A VEHICLE

(75) Inventors: Kenny Clark Jones, Provo, UT (US); Thomas G. Prucha, Rochester Hills, MI (US)

Correspondence Address: HOLLAND & HART LLP, 60 E. South Temple, Suite 2000, P.O. Box 11583, Salt Lake City, UT, 84110, US

(73) Assignee: Raser Technologies, Inc., Provo, UT (US)

(21) Appl. No.: 12/211,002

(22) Filed: Sep. 15, 2008

(51) Int. Cl. H02P 9/04; B60K 6/00

(52) U.S. Cl. 290/40 R; 903/902; 180/65.265

(57) ABSTRACT

A vehicle includes a power supply, at least two auxiliary electrical components, and a load that is shared by the auxiliary electrical components. The two auxiliary electrical components are connected electrically to the power supply in a series configuration. One or more loads may be connected mechanically to the auxiliary electrical components in a parallel configuration. In one embodiment, the two auxiliary electrical components may include at least two compressors for a cooling system.

### TECHNICAL FIELD

The present disclosure relates generally to an improved configuration for powering electrical components in a vehicle. In one application of particular interest, the electrical components may be located in an electric vehicle.

### BACKGROUND

Many vehicles today increasingly rely on electricity to power more and more components and vehicle subsystems. For example, more and more vehicles have electric power steering and/or brake systems instead of the crank driven system so prevalent only a few years ago. Electric pumps and compressors are increasingly being used to replace crank-driven components.

Increased reliance on electricity has especially come to the forefront with the tremendous popularity of vehicles that contain a high voltage battery system such as electric traction vehicles. In a broad sense, electric traction vehicles include both battery-only electric vehicles (EV) and hybrid electric vehicles (HEV). Electric traction vehicles typically include a battery and a high voltage bus that delivers power to various other components in the vehicle.

Electric traction vehicles that are powered only by batteries have been the subject of ongoing research for quite some time. Although they offer a number of advantages, these vehicles have not garnered widespread acceptance primarily due to range constraints and relatively long recharge times. These vehicles also tend to be small and compact, which may further limit their acceptance.

Hybrid electric vehicles have been developed in an attempt to combine the advantages of a battery-only electric vehicle and a traditional internal combustion engine powered vehicle while minimizing the disadvantages. In general, the result is a vehicle that has greater fuel economy while still being capable of traveling long distances. This has positive consequences to the environment as well as to the user.

Hybrid electric vehicles can have a number of different configurations depending on how the combustion and electric propulsion systems are integrated to operate together. The different configurations are usually characterized as a series hybrid system, a parallel hybrid system, or a combination of both. In a pure series hybrid propulsion system, only the electric motor(s) is in direct connection with the drive train and the combustion engine is used to generate electricity which is fed to the electric motor(s). The advantage of this type of system is that the engine can be controlled independently of driving conditions and can therefore be consistently run at its optimum efficiency and low emission ranges.

In a pure parallel hybrid propulsion system, both the combustion engine and the electric traction motor(s) are mechanically connected to the wheels and either one may independently drive the vehicle. Unlike a series hybrid system, the operating point for the engine can not always be chosen with full freedom. Thus, the engine is typically not operated in the most efficient manner. A combination of a series and parallel hybrid system attempts to maximize the advantages of each system.

An advantage of the series hybrid electric vehicle lies in that the series hybrid electric vehicle ideally has high energy efficiency. The drive train mechanism in the parallel hybrid electric vehicle is complicated, since both the engine and the motor are mechanically connected to the drive wheels. A complicated drive train mechanism may cause the loss of the energy. On the contrary, the drive train mechanism of the series hybrid electric vehicle is much simpler. The simplification of the drive train mechanism is effective to minimize the loss, and reduce the weight. Therefore, the series hybrid electric vehicle is excellent in the ideal energy efficiency.

One particularly interesting type of electric traction vehicle is a plug-in series hybrid electric vehicle (PHEV). This vehicle has all the advantages of the series hybrid plus it can be recharged by plugging it into a common electrical receptacle. The user can recharge the vehicle at home or, potentially, in the parking lot at work. This configuration increases the fuel economy of the vehicle because it can now be charged and driven for most trips without using the internal combustion engine.

Regardless of the type, as discussed above, vehicles are increasingly including and relying on auxiliary electrical components to carry out certain functions. For example, vehicles may include compressors to cool various components (e.g., cool the cab, cool the electronics, cool the batteries, etc.). However, the rated voltage for the components in each circuit may vary. For example, the rated voltage for the components used to carry out the cooling function may differ from the rated voltage of pumps used to carry out functions related to the transmission of the vehicle.

Currently, vehicles incorporate DC to DC converters to convert a power supply to a rated voltage level associated with each auxiliary component. DC to DC converters are costly, occupy precious space in the vehicle, and introduce additional inefficiencies into the system. Therefore, it is desired to provide a more efficient design that eliminates the need for converting voltages to a rated voltage for different auxiliary components in a vehicle.

### SUMMARY

A number of embodiments of a vehicle are described herein that include a power supply and a plurality of auxiliary electrical components connected electrically to the power supply in a series configuration. One or more loads is connected to and shared by the plurality of auxiliary electrical components. In one embodiment, a plurality of loads are connected mechanically to the plurality of auxiliary electrical components in a parallel configuration. It should be appreciated that although the subject matter is described herein primarily in the context of an electric vehicle, the subject matter is also applicable to other vehicles (e.g., conventional vehicles powered solely by an internal combustion engine). In fact, the subject matter described herein can be applied to any vehicle, electrical traction or not, that contains a power supply that is twice or more than the nominal voltage rating of multiple electrical components.

In one embodiment, a vehicle comprises a power supply and at least two auxiliary electrical components connected electrically in a series configuration to the power supply. The vehicle also includes one or more loads connected to and shared by the at least two auxiliary electrical components. If more than one load is present, the loads may be connected mechanically to the auxiliary electrical components in a parallel configuration.

In another embodiment, an electric vehicle comprises a power supply and at least two compressors connected electrically in a series configuration to the power supply. The electric vehicle may also include a load connected mechanically to and shared by the at least two compressors.

In another embodiment a method is disclosed for controlling a plurality of auxiliary electrical components in an electric vehicle. The plurality of auxiliary electrical components are connected electrically to a power source in series. The method comprises monitoring the voltage applied to each one of the plurality of auxiliary electrical components. If the voltage applied to a first auxiliary electrical component from the plurality of auxiliary electrical components is outside of an operating parameter then the first auxiliary electrical component is adjusted to bring the voltage back within the operating parameter.

The terms “electric traction vehicle” or “electric vehicle” are used broadly to refer to any vehicle where the wheels can be driven by stored electrical energy. Vehicles included under these terms are battery-only electric vehicles (EV) and hybrid electric vehicles (EV).

The foregoing and other features, utilities, and advantages of the subject matter described herein will be apparent from the following more particular description of certain embodiments as illustrated in the accompanying drawings.

### DRAWINGS

FIG. 1 is a block diagram 100 illustrating one embodiment of an electric traction vehicle.

FIG. 2 is a block diagram illustrating one example of a power supply connected to various auxiliary electrical components in an electric traction vehicle.

FIG. 3 is a block diagram illustrating one embodiment of cooling system components connected together in a series configuration with a battery heat load and a cab heat load connected in a parallel configuration.

FIG. 4 is a flow diagram illustrating one embodiment of a method for controlling a plurality of auxiliary electrical components positioned in series relative to a power source.

### DETAILED DESCRIPTION

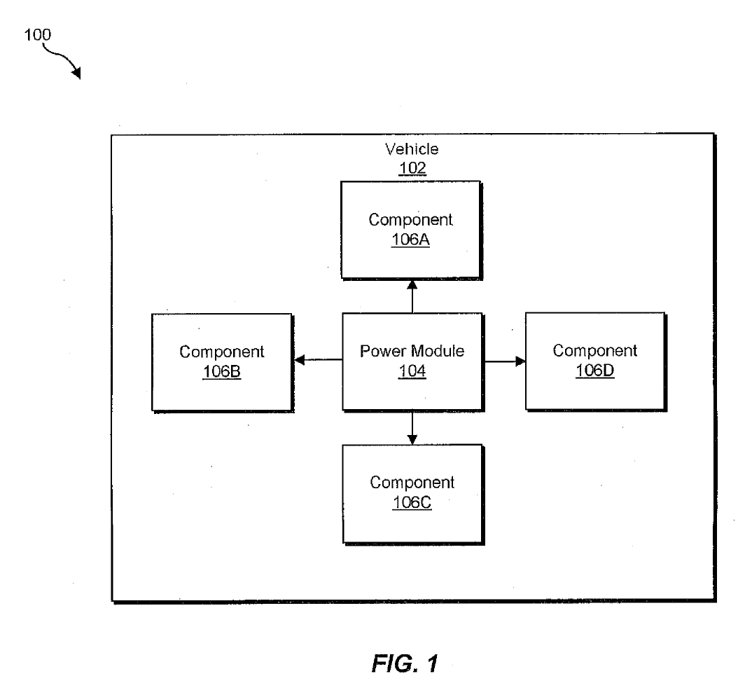

FIG. 1 is a block diagram 100 illustrating one embodiment of an electric fraction vehicle 102. In one embodiment, the electric traction vehicle 102 is a plug-in series hybrid electric vehicle. In another embodiment, the electric traction vehicle 102 may be any of the vehicles discussed above such as an electric vehicle, a hybrid electric vehicle (series or parallel), or any conventional vehicles that are not driven by an electric traction motor.

The electric traction vehicle 102 includes a combustion engine, an on-board, electrical energy generation system and batteries (not shown) in order to achieve improved fuel economy. The electrical energy generation system allows the electric traction vehicle 102 to operate for a greater distance than a battery-only vehicle that uses batteries charged by an external source. The use of stored electrical energy to power the electric traction vehicle 102 reduces its emissions and cost to operate.

In one embodiment, the electric traction vehicle 102 includes a power module 104. The power module 104 may include one or more high voltage batteries that supply power to one or more electrical components 106A, 106B, 106C, 106D of the electric traction vehicle 102. The components 106A, 106B, 106C, 106D may be auxiliary components on the electric traction vehicle 102 such as a compressor for a cooling system, pump, motor, etc. The electrical components 106A, 106B, 106C, 106D are considered to be auxiliary components because they are part of systems that are auxiliary to the main electrical or mechanical propulsion system. Details regarding the power module 104 and the various components 106A, 106B, 106C, 106D will be described below in detail.

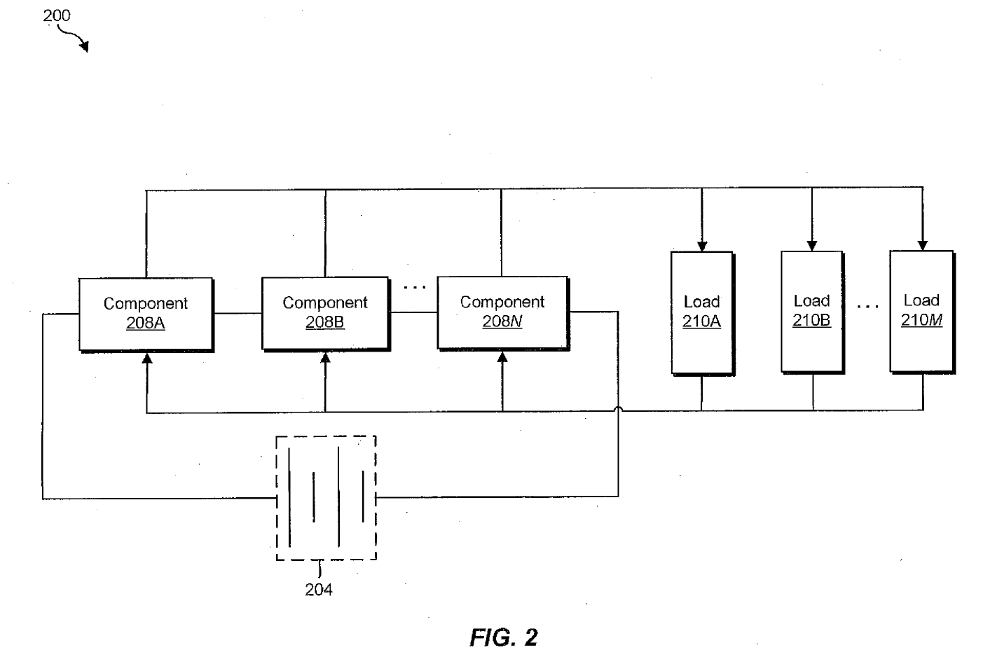

FIG. 2 is a block diagram 200 illustrating one example of a power supply 204 connected to auxiliary electrical components 208A, 208B, 208N (collectively referred to as auxiliary electrical components 208) in an electric traction vehicle 102. While three components are illustrated in FIG. 2, two or more components may be used in the present systems and methods. In one configuration, the power supply 204 is a 700-volt (V) battery. The components 208A, 208B, 208N may be connected electrically in series to the high voltage bus so that the sum of the voltage drops across the individual components is approximately 700 volts. The components 208A, 208B, 208N may be compressors, pumps, DC motors, etc.

The voltage drop across each component 208A, 208B, 208N should be such that the voltage drop across all of the components 208 equals the voltage of the power supply 204 (i.e., 700 V). In one embodiment, the voltage drop across each component 208A, 208B, 208N is roughly equal. For example, if three components are connected in series to a 700-volt power supply 204, the voltage drop across each component may be approximately 233.3 volts, and the total voltage drop across the three components is equal to 700-volts.

The auxiliary electrical components 208A, 208B, 208N are connected to one or more loads 210A, 210B, 210M (collectively referred to herein as loads 210). The load 210 is shared by each of the auxiliary electrical components 208A, 208B, 208N. In one embodiment, the auxiliary electrical components 208 may be connected to a single shared load 210. In another embodiment, the auxiliary electrical components 208 may be connected to multiple loads 210. The two or more loads 210 may be connected to the auxiliary electrical components 208 in a parallel configuration, as shown in FIG. 2. With the loads 210A, 210B, 210M connected in parallel, the power draw of each component 208A, 208B, 208N is equal even though the individual loads 210 may or may not be equal.

The parallel configuration of the loads 210 to the auxiliary electrical components 208 may be desirable because it evens out the power draw for each component 208 regardless of individual loads 210. Because the power draw by each of the components 208 is equal, multiple components 208 can be used without a DC/DC convertor. Thus there may be no need to otherwise use a DC/DC convertor to provide the power necessary for each component 208A, 208B, 208N alone. In other words, the configuration illustrated in FIG. 2 may eliminate the need for a converter to convert the voltage of the power supply to a rated voltage of each individual component 208A, 208B, 208N.

The number of components 208 that can be connected in series depends on the rated voltage of each component 208 and the voltage output from the power supply 204. In general, multiple components 208 may be connected in series to the power supply 204 so long as the power supply voltage is twice or more the rated voltage of the auxiliary electrical components 208. The number of components 208 that can be connected in series is approximately the same as the multiple of the power supply voltage to the rated voltage of each component 208. If the power supply voltage is roughly twice the rated voltage of the components 208, then two components 208 may be connected in series. If the power supply voltage is roughly three times the rated voltage of the components 208, then three components 208 may be connected in series.

In the one embodiment, the vehicle 102 may include a control system that controls the auxiliary electrical components 208 to make sure that they operate within certain parameters. In one embodiment, the control system may be configured to ensure that the auxiliary electrical component 208 maintain the desired voltage drop across each component 208. If the voltage drop exceeds a maximum or falls below a minimum, the affected component 208 and/or the other attached components may shut down or be damaged.

The voltage drop across each component 208 may be measured in a number of ways. In one embodiment, the voltage drop may be measured directly. In another embodiment, the voltage drop may be approximated by monitoring the power usage of the component 208. The mathematical relationship between power, voltage, and current can be used to approximate the voltage drop.

If the voltage drop is determined to be outside of parameters, the control system can compensate by increasing or decreasing power to the component 208. For example, if the component 208 is a pump or a compressor, the control system may increase or decrease the speed of the pump or compressor to increase or decrease the voltage drop. If the voltage drop across the component 208 is not brought within specifications by this adjustment, the control system may be configured to restart the component 208. If the voltage drop is still outside of the preset operating parameters, the control system may be configured to shut down all of the components 208 that are connected together in series to prevent the other components 208 from being damaged.

In one embodiment, the voltage drop across each component 208 may be implemented using closed-loop control logic. For example PID (proportional, integral, derivative) control may be used to maintain the voltage drop across each component 208 within the desired parameters.

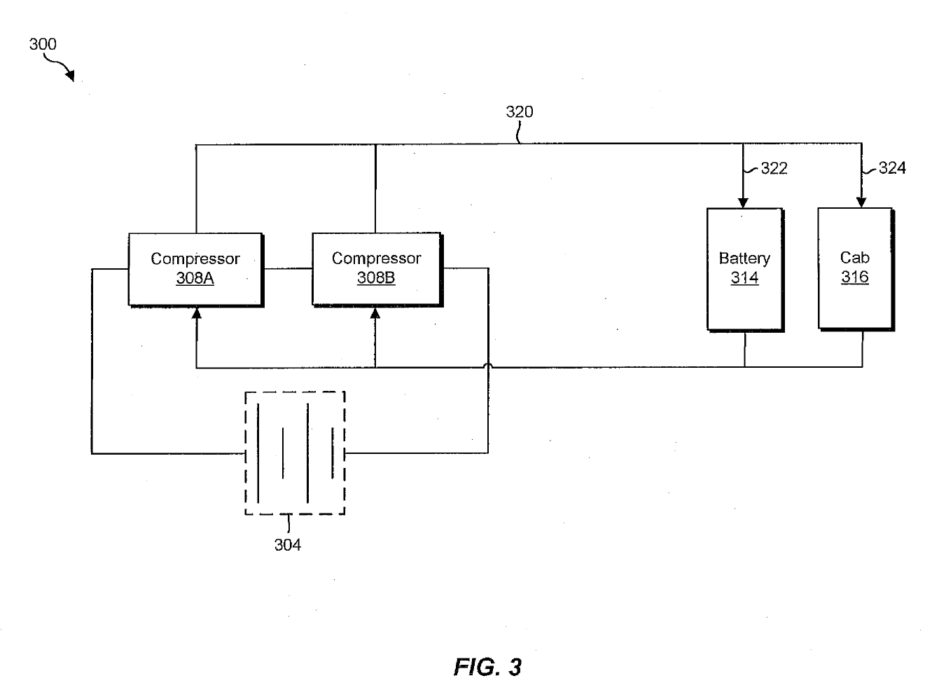

FIG. 3 is a block diagram 300 illustrating one embodiment of a cooling system. The cooling system includes compressors 308A, 308B, connected together electrically in a series configuration. A battery heat load 314 and a cab heat load 316 are connected mechanically to the compressors 308A, 308B in a parallel configuration. The battery heat load 314 and the cab heat load 316 refer to the heat loads of the battery (or batteries) and cab of the electric traction vehicle 102.

In one example, the compressors 308A, 308B are connected to a power supply 304. The power supply 304 may be a high voltage bus. For example, the power supply 304 may be a 700-volt battery. As previously mentioned, the voltage drop across each of the compressors 308A, 308B may be equal. In this example, the voltage drop across each compressor 308A, 308B may be approximately 350 V. The total voltage drop across the compressor 308A, 308B may be approximately 700 V.

The compressors 308A, 308B are used to pressurize a gas which is subsequently fed into a condenser (not shown). The compressed gas undergoes a phase change at the condenser from a gas to a liquid. The latent heat associated with the gas is transferred from the gas to the surrounding environment, thereby giving off heat. The coolant is now in the form of a liquid. The coolant used by the cooling system may be any suitable refrigerant, such as without limitation R-22 (Freon).

In one embodiment, the liquid coolant output from the compressors 308A, 308B and the condenser is combined into a single stream 320. The liquid coolant stream 320 is fed to one or more evaporators where the pressure is reduced (e.g. an expansion valve) and the liquid changes back into a gas. As the liquid changes phase it absorbs heat thereby cooling the surrounding environment. In one embodiment, the cooled fluid may be used to cool an air stream that is, in turn, used to satisfy the cab heat load 316. In another embodiment the cooled fluid may be used directly to absorb heat by passing the cooled fluid directly through a manifold that is part of the battery. In this way, the cooled fluid is capable of satisfying the battery heat load 314. It should be appreciated that the heat exchange between the cooled fluid and the heat load may be accomplished using any of a number of different configurations.

The heat loads 314, 316 are connected mechanically to the components 308A, 308B in parallel. This can be accomplished in any of a number of ways. In one embodiment, the liquid stream 320 may be split and fed to two different evaporators associated with each heat load 314, 316, as depicted in FIG. 3. In another embodiment the liquid stream 320 may be fed to a single evaporator coil, which cools an air stream. The air stream that leaves the evaporator coil may be split into two air streams and directed to each of the battery heat load 314 and the cab heat load 316. It should also be appreciated that the loads 314, 316 may be dynamic so that different amounts of cooling may be provided to the loads 314, 316 at any given time. After absorbing heat from the heat loads 314, 316, the gas is transferred back to the compressors 308A, 308B and the process begins anew.

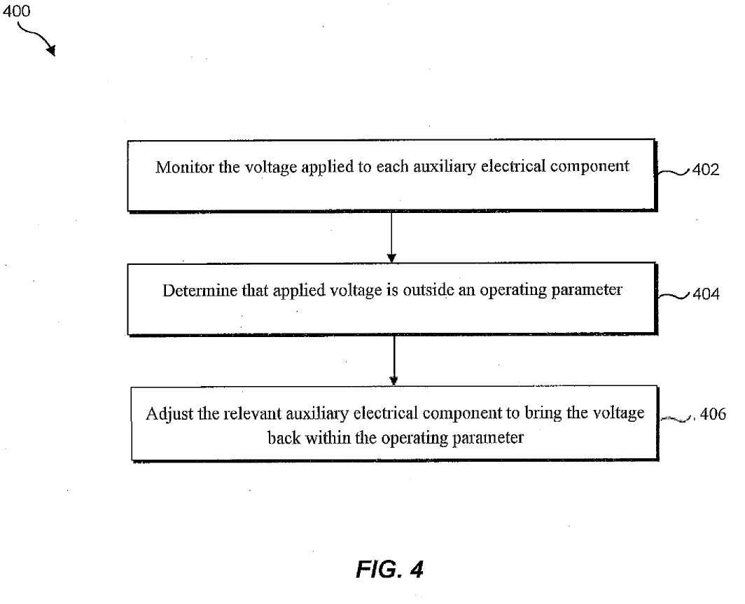

FIG. 4 is a flow diagram illustrating one embodiment of a method 400 for controlling a plurality of auxiliary electrical components connected in series with load sharing. In one embodiment, the voltage applied to each auxiliary electrical component is monitored 402 to determine 404 if the voltage is outside of an operating parameter. As mentioned above, the voltage may be approximated by measuring the power used by auxiliary electrical component. If the voltage is outside of the operating parameter, then the auxiliary electrical component is adjusted 406 to bring it back within the parameter. This may involve increasing the speed of the auxiliary electrical component, restarting one or all of the auxiliary electrical components, shutting down one or all of the auxiliary electrical components, or taking other appropriate action.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

As used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A vehicle comprising:
a power supply;
at least two auxiliary electrical components connected electrically in a series configuration to the power supply; and
a load connected to and shared by the at least two auxiliary electrical components.

2. The vehicle of claim 1, comprising at least two loads connected mechanically to the at least two auxiliary electrical components in a parallel configuration.

3. The vehicle of claim 2, wherein the at least two loads are connected in parallel to the at least two auxiliary electrical components by a common fluid flow that is divided and directed to each of the at least two loads.

4. The vehicle of claim 1, wherein the power supply is a high voltage bus supplying a predetermined amount of voltage.

5. The vehicle of claim 4, wherein the voltage applied to each of the at least two auxiliary electrical components is equal.

6. The vehicle of claim 1, wherein the at least two auxiliary electrical components include at least two compressors for a cooling system that cools one or more areas of the vehicle.

7. The vehicle of claim 6, wherein the one or more areas of the vehicle include a cab and one or more batteries.

8. The vehicle of claim 1, wherein the at least two auxiliary electrical components include at least two pumps.

9. The vehicle of claim 1, comprising control logic that prevents the voltage applied to at least one of the auxiliary electrical components from deviating outside of a set parameter.

10. An electric vehicle comprising:
a power supply;
at least two compressors connected electrically in a series configuration to the power supply; and
a load connected mechanically to and shared by the at least two compressors.

11. The electric vehicle of claim 10, comprising at least two loads connected mechanically to the at least two compressors in a parallel configuration.

12. The electric vehicle of claim 11, wherein the at least two loads are connected in parallel to the at least two compressors by a common fluid flow that is divided and directed to each of the at least two loads.

13. The electric vehicle of claim 12, wherein the common fluid flow includes a refrigerant fluid.

14. The electric vehicle of claim 10, wherein the power supply is a high voltage bus supplying a predetermined amount of voltage.

15. The electric vehicle of claim 10, wherein the power supply supplies approximately 700 Volts to the at least two compressors.

16. The electric vehicle of claim 10, wherein the voltage applied to each of the at least two compressors is equal.

17. The electric vehicle of claim 10, wherein the at least two compressors and the load are part of a cooling system that cools one or more areas of the electric vehicle.

18. The electric vehicle of claim 17, wherein the one or more areas of the vehicle include a cab and one or more batteries.

19. The electric vehicle of claim 18, wherein the electric vehicle includes wheels, wherein the one or more batteries provide power to drive the wheels.

20. A method for controlling a plurality of auxiliary electrical components in an electric vehicle, the method comprising:
monitoring the voltage applied to each one of the plurality of auxiliary electrical components, the plurality of auxiliary electrical components being connected electrically to a power source in series;
determining that the voltage applied to a first auxiliary electrical component from the plurality of auxiliary electrical components is outside of an operating parameter; and
adjusting the first auxiliary electrical component to bring the voltage back within the operating parameter.

21. The method of claim 20, wherein the voltage applied to each of the plurality of auxiliary electrical components is approximately equal.

22. The method of claim 20, wherein the operating parameter is a voltage range.

23. The method of claim 20, wherein the plurality of auxiliary electrical components include a plurality of compressors for a cooling system.

24. The method of claim 23, wherein adjusting the first compressor includes changing the speed of the first compressor.
